(19) United States
(12) Patent Application Publication
(10) Pub. No.: US 2005/0175367 A1
(43) Pub. Date: Aug. 11, 2005

(54) Fixing device, image forming apparatus, and fixing method

(75) Inventor: Kenji Urabe, Tagata-gun (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/775,179

(22) Filed: Feb. 11, 2004

(51) Int. Cl. G03G 15/20

(52) U.S. Cl. 399/69

(57) ABSTRACT

A center thermistor 13 associated with a center heater 11 within a heat roller 10 and a side thermistor 14 associated with a side heater 12 within the heat roller 10 are arranged in phase in a circumferential direction of the heat roller 10. In standby state, in a period immediately after the start of printing and in a period immediately after the end of printing, a control temperature based on a detection temperature of the thermistor 13 or 14 has a value that is obtained by making correction to a reference control-target value.

### BACKGROUND OF THE INVENTION

1. Field of the Invention

The present invention relates to a fixing device that fixes a toner image, which is transferred to paper by an electrophotographic process, on the paper.

2. Description of the Related Art

In the prior art, there is known an image forming apparatus such as a copying machine, which uses a fixing device that fixes a toner image on paper by a combination of a heat roller, which is heated by a heater lamp, and a press roller. In such a fixing device, for example, a plurality of heater lamps are disposed in the heat roller. The fixing device is provided with temperature detection means such as thermistors, which detect surface temperatures of the heat roller at regions associated with respective heating sections. In the fixing device, the respective heater lamps are switched on and off in accordance with temperatures that are detected by the temperature detection means. At a time of warming up, for example, the heater lamps are turned on at the same time, while no power is consumed in other units. Thereby, the warming-up time is shortened. If this control is adopted, the surface temperature of the heat roller can be stably controlled at the time of printing, e.g. copying. Thus, the quality of the fixing process can be maintained, regardless of the size of paper sheets.

However, depending on the positions of arrangement of the heater lamps and those of the thermistors, a temperature difference occurs in surface temperature between the end portion and central portion of the heat roller in the standby state in which the heat roller stands at rest. In addition, in recent years, in order to shorten the warming-up time, the wall thickness of the heat roller that is used in the fixing device tends to be decreased. If the wall thickness of the heat roller is decreased, such a temperature difference may conspicuously occur in many cases.

Furthermore, in recent years, in the image forming apparatus having the above-described fixing device, the time for fast copying has been shortened and the size of the unit itself has been reduced, in addition to the decrease in warm-up time. Consequently, in the image forming apparatus including the fixing device, there is such a case where printing on several sheets of paper, from the first one, may be performed under the adverse effect of the non-uniform surface temperature of the heat roller in the standby state. In this case, as regards the uniformity in surface temperature of the heat roller, it is necessary to make a compromise with such a level of uniformity as to keep a minimum quality of fixation, or to dispose the temperature control elements such as thermistors with some positional constraints.

### BRIEF SUMMARY OF THE INVENTION

The object of the present invention is to provide a fixing device, which can maintain a uniform surface temperature of a heat roller in a standby state, immediately after the start of printing, or immediately after the end of printing, and which can realize a stable control of a heater lamp, without imposing constraints on the position of arrangement of a thermistor that functions as temperature detection means.

According to an aspect of the present invention, there is provided a fixing device comprising: a substantially cylindrical heat roller that is used for fixing toner on paper; a center heater disposed within the heat roller, the center heater being located at a center region in a longitudinal direction of the heat roller and at a position displaced in a first direction from a diametrical center position of the heat roller; a side heater disposed within the heat roller, the side heater being located at a side region in the longitudinal direction of the heat roller and at a position displaced in a second direction from the diametrical center position of the heat roller; a first temperature detection element that detects a surface temperature of the heat roller at a position where a position in the longitudinal direction of the heat roller corresponds to the center heater; and a second temperature detection element that is positioned in phase with the first temperature detection element in a circumferential direction of the heat roller, and detects a surface temperature of the heat roller at a position where a position in the longitudinal direction of the heat roller corresponds to the side heater.

According to another aspect of the present invention, there is provided a fixing device comprising: a substantially cylindrical heat roller that is used for fixing toner on paper; a center heater disposed within the heat roller, the center heater being located at a center region in a longitudinal direction of the heat roller and at a position above a diametrical center position of the heat roller; a side heater disposed within the heat roller, the side heater being located at a side region in the longitudinal direction of the heat roller and at a position below the diametrical center position of the heat roller; a drive mechanism that rotates the heat roller in a circumferential direction thereof; a first temperature detection element that detects a surface temperature of the heat roller at a position where a position in the longitudinal direction of the heat roller corresponds to the center heater; a second temperature detection element that is positioned in phase with the first temperature detection element in the circumferential direction of the heat roller, and detects a surface temperature of the heat roller at a position where a position in the longitudinal direction of the heat roller corresponds to the side heater; and a control section that controls, when driving of the heat roller is started by the drive mechanism, turning the center heater on and off using, as a control-target value of the surface temperature of the heat roller, a value that is obtained by correcting a reference control-target value for the surface temperature of the heat roller on the basis of a positional relationship between the center heater and the first temperature detection element, and also controls turning the side heater on and off using, as a control-target value of the surface temperature of the heat roller, a value that is obtained by correcting the reference control-target value for the surface temperature of the heat roller on the basis of a positional relationship between the side heater and the second temperature detection element.

According to still another aspect of the present invention, there is provided a fixing device comprising: a substantially cylindrical heat roller that is used for fixing toner on paper; a center heater disposed within the heat roller, the center heater being located at a center region in a longitudinal direction of the heat roller and at a position above a diametrical center position of the heat roller; a side heater disposed within the heat roller, the side heater being located at a side region in the longitudinal direction of the heat roller and at a position below the diametrical center position of the heat roller; a drive mechanism that rotates the heat roller in a circumferential direction thereof; a first temperature detection element that detects a surface temperature of the heat roller at a position where a position in the longitudinal direction of the heat roller corresponds to the center heater; a second temperature detection element that is positioned in phase with the first temperature detection element in the circumferential direction of the heat roller, and detects a surface temperature of the heat roller at a position where a position in the longitudinal direction of the heat roller corresponds to the side heater; and a control section that controls, when driving of the heat roller is stopped by the drive mechanism, turning the center heater on and off using, as a control-target value of the surface temperature of the heat roller, a value that is obtained by correcting a reference control-target value for the surface temperature of the heat roller on the basis of a positional relationship between the center heater and the first temperature detection element, and also controls turning the side heater on and off using, as a control-target value of the surface temperature of the heat roller, a value that is obtained by correcting the reference control-target value for the surface temperature of the heat roller on the basis of a positional relationship between the side heater and the second temperature detection element.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a fixing device according to an embodiment of the present invention;

FIG. 2 is a cross-sectional view showing the structure of a heat roller and its peripheral components in the fixing device;

FIG. 3 shows the structure of a control system of the fixing device;

FIG. 4 shows an example of control temperatures for the surface temperature of the heat roller;

FIG. 5 is a flowchart illustrating a temperature control for the surface temperature of the heat roller in a case where the driving of the heat roller is started; and

FIG. 6 is a flowchart illustrating a temperature control for the surface temperature of the heat roller in a case where the driving of the heat roller is stopped.

### DETAILED DESCRIPTION OF THE INVENTION

An embodiment of the present invention will now be described with reference to the accompanying drawings.

FIG. 1 is a cross-sectional view for schematically illustrating the structure of a main part of a fixing device 1 according to the embodiment of the invention.

The fixing device 1 is used in a well-known image forming apparatus such as a digital multi function peripheral, which performs image formation using electrophotography.

As is shown in FIG. 1, the fixing device 1 includes a heat roller 10 that is a member to be heated. The heat roller 1 contains a heater lamp for a central region (hereinafter referred to as a “center heater”) 11 and heater lamps for side regions (hereinafter “side heaters”) 12, which heat the heat roller 10.

The center heater 11 has such heat distribution characteristics as to mainly heat a central portion (hereinafter “center part”) in a longitudinal direction of the heat roller 10. The side heaters 12 have such heat distribution characteristics as to mainly heat both end portions (hereinafter “side parts”) in the longitudinal direction of the heat roller 10.

In the description below, the central portion in the longitudinal direction of the heat roller 10 (i.e. a region corresponding to the center heater 11) is referred to as a “center region”, and both end portions in the longitudinal direction of the heat roller 10 (i.e., regions corresponding to side heaters 12) are referred to as “side regions”).

In the fixing device 1, the sum of an electric power of the center heater 11 and an electric power of the side heaters 12 is set to be substantially equal to an electric power that can be supplied when the digital multi function peripheral, in which the fixing device 1 is used, is switched on. In addition, the electric power of the center heater 11 is set to be equal to the electric power of the side heaters 12.

For example, the center heater 11 comprises a heater lamp having a heater filament of 600 W, and each side heater 12 comprises a heater lamp having a heater filament of 300 W. The filaments used in the center heater 11 and side heaters 12 have the same length.

A maximum paper pass width W, shown in the Figure, is set at a predetermined width (maximum-size paper width), with a reference position being set at the center in the longitudinal direction of the heat roller 10. The maximum paper pass width W indicates the width (sheet width) of a maximum-size paper sheet, on which a toner image can be fixed by means of the heat roller 10. The maximum paper pass width W is set to be less than the longitudinal length of the heat roller 10. Hence, non-paper-pass sections are formed on the heat roller 10 on the outside of the maximum paper pass width W.

A thermistor (hereinafter referred to also as a “center thermistor”) 13, which functions as a first temperature detection element for detecting the surface temperature of the heat roller 10 that is heated by the center heater 11, is provided in the center region in the longitudinal direction of the heat roller 10. A thermistor (hereinafter referred to also as a “side thermistor”) 14, which functions as a second temperature detection element for detecting the surface temperature of the heat roller 10 that is heated by the each side heater 12, is provided in each side region in the longitudinal direction of the heat roller 10. In addition, a thermistor (hereinafter referred to also as an “edge thermistor”) 15 for detecting the temperature of the non-paper-pass section is provided at the non-paper-pass section in the longitudinal direction of the heat roller 10.

A center thermostat 16, which serves as a first power-off element, is disposed at a center position in the center region (i.e., the center position in the longitudinal direction of heat roller 10). A side thermostat 17, which serves as a second power-off element, is disposed at a center position in the side region. The thermostats 16 and 17 turn off power to the center heater 11 and side heater 12 when the temperature rises up to an over heat temperature (i.e. predetermined temperature for device protection), thereby protecting the fixing device 1.

The fixing device 1 is provided with a drive mechanism 19 for rotating the heat roller 10. The drive mechanism 19 includes, for instance, a drive motor and gears for transmitting power of the drive motor to the heat roller 10. The drive mechanism 19 rotates the heat roller 10 under the control of a control section 21 (to be described later).

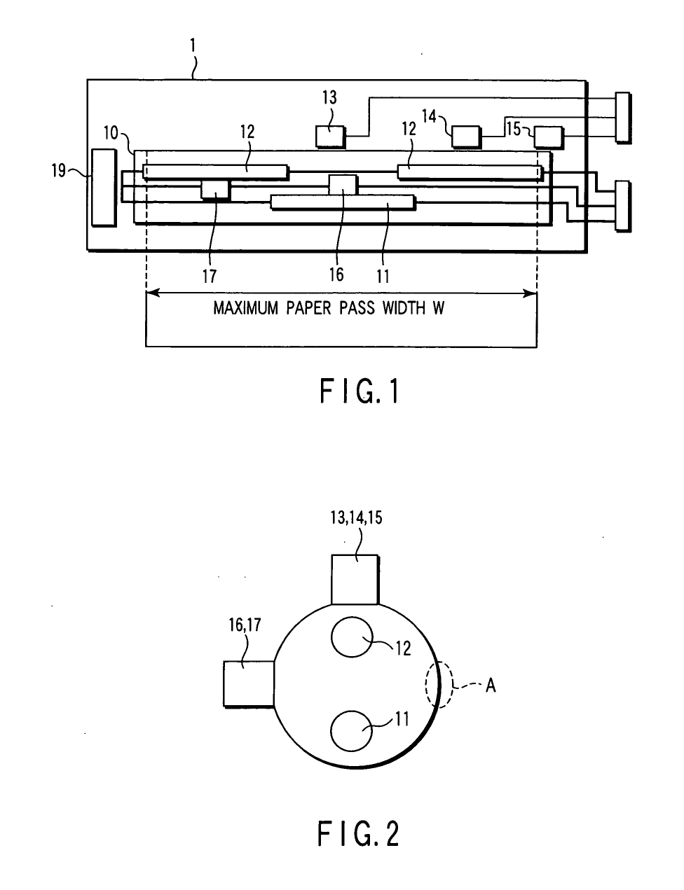

FIG. 2 is a cross-sectional view showing the structure of the heat roller 10 and its peripheral components.

As is shown in FIG. 2, the heat roller 10 performs a fixing process on paper, to which toner is transferred, at a region A indicated in FIG. 2. In the region A, a press roller (not shown) is disposed to face the heat roller 10. Thereby, in the region A, heat from the heat roller 10 and pressure, which acts between the heat roller 10 and press roller (not shown), are applied to the paper with the transferred toner. Thus, the toner image is fixed.

The center heater 11, as shown in FIG. 2, is disposed within the heat roller 10 on a lower side position (i.e., displaced in a first direction) of the diametrical center of the heat roller 10. This position is referred to as a “first position”. The side heater 12, as shown in FIG. 2, is disposed within the heat roller 10 on an upper side position (i.e., displaced in a second direction) of the diametrical center of the heat roller 10. This position is referred to as a “second position”.

The thermistors 13, 14 and 15 are disposed at positions corresponding to the heater lamps 11 and 12, as shown in FIG. 1, in the longitudinal direction of the heat roller 10. The thermistors 13, 14 and 15 are disposed on the upper side surface of the heat roller 10 in the diametrical direction of the heat roller 10, as shown in FIGS. 1 and 2.

Next, the positions of arrangement of the thermistors 13, 14 and 15 are described in detail.

The thermistor 13, as shown in FIGS. 1 and 2, is disposed on the surface of the heat roller 10, which corresponds to the center heater 11, so as to detect the surface temperature of the heat roller 10 (i.e., surface temperature of the upper part of the heat roller 10, which corresponds to the center heater 11) on a side that is opposed to the center heater 11 with respect to the diametrical center of the heat roller 10.

The thermistor 14, as shown in FIGS. 1 and 2, is disposed on the surface of the heat roller 10, which corresponds to the side heater 12, so as to detect the surface temperature of the heat roller 10 (i.e., surface temperature of the upper part of the heat roller 10, which corresponds to the side heater 12) on a side that is close to the side heater 12 with respect to the diametrical center of the heat roller 10. The thermistor 14 and thermistor 13 are disposed on the same side with respect to the center of the heat roller 10, and are juxtaposed in a direction parallel to the longitudinal direction of the heat roller 10.

The thermistor 15, as shown in FIGS. 1 and 2, is disposed on the non-paper-pass section of the heat roller 10 on the same side as the thermistors 13 and 14 with respect to the center of the heat roller 10, and these thermistors are juxtaposed in a direction parallel to the longitudinal direction of the heat roller 10.

It should suffice if the thermistors 13, 14 and 15 are juxtaposed in a direction parallel to the longitudinal direction of the heat roller 10. For example, they may be disposed on the lower side of the heat roller 10. In the case where the thermistors 13, 14 and 15 are arranged on the lower side of the heat roller 10 (i.e., on the side opposite to the position of arrangement shown in FIGS. 1 and 2), a control similar to an on/off control for the center heater 11 based on the detection temperature of the thermistor 13, which is described later, may be executed as an on/off control for the side heater 12 based on the detection temperature of the thermistor 14. The positional relationship between the center heater 11 and side heater 12 is not limited to the lower/upper side relationship. The center heater 11 may be disposed at any position if it can heat the center part of the heat roller 10. Besides, the side heater 12 may be disposed at any position if it can heat the side part of the heat roller 10, which is displaced from the center heater 11 in the circumferential direction of the heat roller 10.

On the other hand, as shown in FIGS. 1 and 2, the thermostats 16 and 17 functioning as power-off elements are disposed on the surface of the heat roller 10. The thermostats 16 and 17 are safety devices for forcibly turning off power to the center heater 11 and side heater 12 in case of abnormal heating of the heat roller 10 due to abnormal turn-on of the center heater 11 and side heater 12.

It is thus necessary that the thermostats 16 and 17 be disposed at optimal positions relative to the heat roller 10. As mentioned above, the center heater 11 is disposed on the lower side of the diametrical center of the heat roller 10. In other words, the center heater 11 is disposed near the lower side of the heat roller 10. The side heater 12 is disposed on the upper side of the diametrical center of the heat roller 10. In other words, the side heater 12 is disposed near the upper side of the heat roller 10. Consequently, when a turn-on abnormality occurs in the center heater 11, the lower side of the heat roller 10 tends to reach an abnormal temperature, earlier than the upper side of the heat roller 10. If a turn-on abnormality occurs in the side heater 12, the upper side of the heat roller 10 tends to reach an abnormal temperature, earlier than the lower side of the heat roller 10.

For this reason, the thermostats 16 and 17 are disposed, as shown in FIG. 2, at a position (opposed to the region A of the heat roller) where they have the same distance to the center heater 11 and side heater 12 in the diametrical direction of the heat roller 10.

If the thermostats 16 and 17 are disposed at the above-mentioned position, it is necessary to dispose the thermistors 13, 14 and 15 on the upper side or lower side of the heat roller 10, as shown in FIGS. 1 and 2. The reason for this is that the thermostats 16 and 17 are wired to a DC power supply, while the thermistors 13, 14 and 15 are wired to an AC power supply. For example, if the thermostats 16 and 17 and the thermistors 13, 14 and 15 are disposed at the same position (in the same phase) in the circumferential direction of the heat roller 10, the thermistors 13, 14 and 15 tend to be easily affected by noise from the DC wiring. As a result, the wiring for the thermostats 16 and 17 and the wiring for the thermistors 13, 14 and 15 become complex.

For this reason, in the fixing device of this embodiment, the thermostats 16 and 17 are disposed to be opposed to the region A of the heat roller 10, and the thermostats 16 and 17 and the thermistors 13, 14 and 15 are disposed so as not to be in phase. Thereby, this fixing device can maintain the precision of detection of the thermistors 13, 14 and 15, and the respective components are arranged with high efficiency.

Further, in this fixing device, in order to reduce the size of the entire device, the thermistors 13, 14 and 15 are juxtaposed in a direction parallel to the longitudinal direction of the heat roller 10. The reason is that if the thermistors 13, 14 and 15 are arranged at different positions in the circumferential direction of the heat roller 10, the size of the entire fixing device is increased in order to secure the positions of arrangement of the thermistors.

In addition, if the thermistors 13, 14 and 15 are arranged at different positions in the circumferential direction of the heat roller 10, there arise problems with the wiring for the thermistors and the structures thereof, in addition to the necessity for securing the positions of arrangement of the thermistors. For example, if the thermistor 13 is disposed on the lower side of the heat roller 10 and the thermistor 14 is disposed on the upper side of the heat roller 10, wiring for the lower-side thermistor 13 and wiring for the upper-side thermistor 14 are individually required.

For these reasons, in this fixing device, the thermistors 13, 14 and 15 are juxtaposed in a direction parallel to the longitudinal direction of the heat roller 10. Thereby, it is possible to provide the fixing device, which can realize reduction in side and efficient wiring for the thermistors 13, 14 and 15.

Next, an example of the structure of a control system for the fixing device 1 is described.

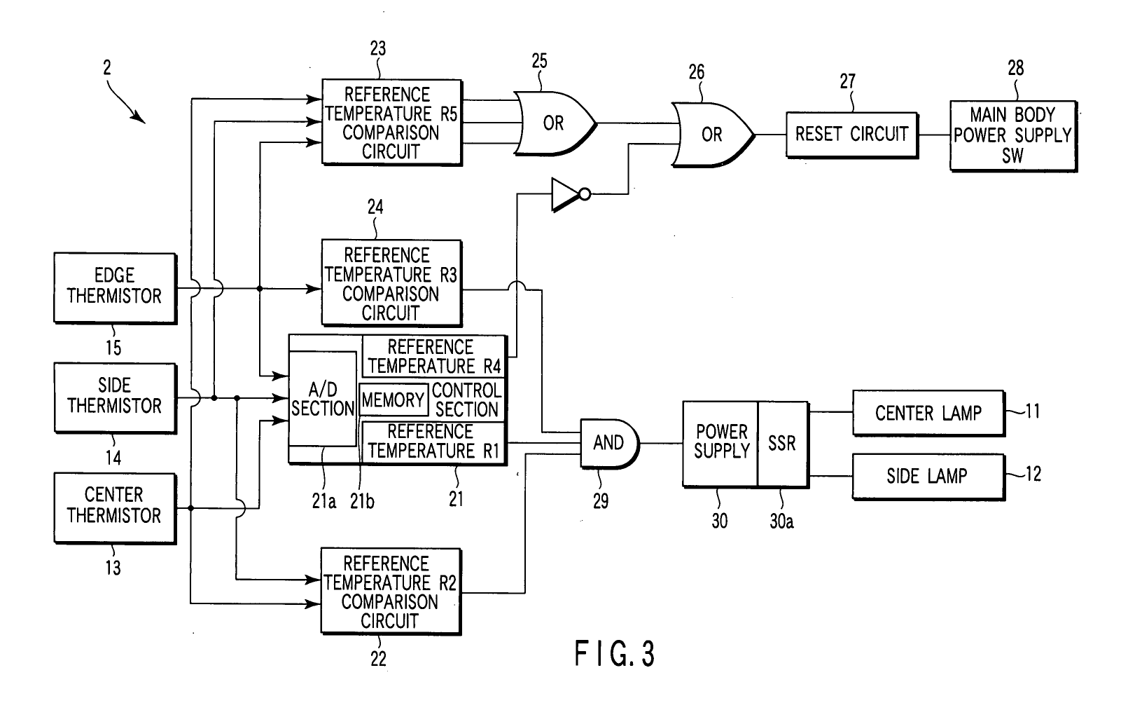

FIG. 3 shows an example of the structure of a control system for the heater lamps (center heater 11 and side heaters 12) of the fixing device 1.

As is shown in FIG. 3, outputs from the center thermistor 13 and side thermistor 14 are delivered to a control section 21, a reference temperature R2 comparison circuit 22 and a reference temperature R5 comparison circuit 23. In addition, an output from the edge thermistor 15 is delivered to the control section 21, a reference temperature R3 comparison circuit 24 and the reference temperature R5 comparison circuit 23.

The control section 21 includes an A/D section 21a, a CPU (not shown), a ROM (not shown), a memory 21b, and a clock section (not shown). The control section 21 comprehensively controls, for example, the digital multi-function peripheral using the fixing device 1. The CPU executes various processes based on control programs stored in the ROM and various settings stored in the memory. The clock section generates clock information. The CPU calculates time, using the clock section. The ROM stores a reference temperature (fixation control temperature) R1, a reference temperature (first protection control temperature) R4, and various control programs that are executed by the CPU. The memory 21b stores, for instance, various setting times (to be described later). The memory 21b also stores correction values (to be described later). For example, the A/D section 21a converts analog signals, which represent temperatures detected by the center thermistor 13, side thermistor 14 and edge thermistor 15, to digital signals.

The control programs include a control program for comparing the temperatures, which are detected by the center thermistor 13, side thermistor 14 and edge thermistor 15 and are converted to digital signals, with the reference temperature R1 and reference temperature R4.

Based on the control program, the CPU of the control section 21 compares the temperatures detected by the thermistors 13, 14 and 15 with the reference temperature R1. If the comparison result shows that all the detection temperatures of the thermistors 13, 14 and 15 are within the range of reference temperature R1, the CPU delivers an output signal “1” to an AND gate 29. If any one of the detection temperatures of the thermistors 13, 14 and 15 is out of the range of reference temperature R1, the CPU delivers an output signal “0” to the AND gate 29.

In addition, based on the control program, the CPU of the control section 21 compares the temperatures detected by the thermistors 13, 14 and 15 with the reference temperature R4. If the comparison result shows that all the detection temperatures of the thermistors 13, 14 and 15 are within the range of reference temperature R4, the CPU of the control section 21 delivers an output signal “1” to an OR gate 26. If any one of the detection temperatures of the thermistors 13, 14 and 15 is out of the range of reference temperature R4, the CPU delivers an output signal “0” to the OR gate 26.

The reference temperature R2 comparison circuit 22 compares output signals from the center thermistor 13 and side thermistor 14 with a reference temperature (fixation control temperature) R2. If the comparison result shows that the output signals from the center thermistor 13 and side thermistor 14 are within the range of reference temperature R2, the reference temperature R2 comparison circuit 22 delivers an output signal “1” to the AND gate 29. If the comparison result shows that the output signals from the center thermistor 13 and side thermistor 14 are out of the range of reference temperature R2, the reference temperature R2 comparison circuit 22 delivers an output signal “0” to the AND gate 29.

The reference temperature R3 comparison circuit 24 compares an output signal from the edge thermistor 15 with a reference temperature R3. If the comparison result shows that the output signal from the edge thermistor 15 is within the range of reference temperature R3, the reference temperature R3 comparison circuit 24 delivers an output signal “1” to the AND gate 29. If the comparison result shows that the output signal from the edge thermistor 15 is out of the range of reference temperature R3, the reference temperature R3 comparison circuit 24 delivers an output signal “0” to the AND gate 29.

The AND gate 29 performs AND operations on the basis of outputs from the control section 21, reference temperature R2 comparison circuit 22 and reference temperature R3 comparison circuit 24. For example, if the detection temperatures of the center thermistor 13 and side thermistor 14 are within the ranges of reference temperatures R1 and R2 and the detection temperature of the edge thermistor 15 is within the range of reference temperature R3, the AND gate 29 delivers an output signal “1” to a power supply 30.

The power supply 30 supplies power to the center heater 11 and side heater 12. The power supply 30 includes an SSR (Solid-State Relay) 30a. If the power supply 30 receives, for example, an output signal “1” from the AND gate 29, the power supply 30 supplies power to the center heater 11 and side heater 12.

The reference temperature R5 comparison circuit 23 compares temperature signals output from the center thermistor 13, side thermistor 14 and edge thermistor 15 (i.e., signals representative of temperatures detected by center thermistor 13, side thermistor 14 and edge thermistor 15) with a reference signal (second protection control temperature) R5. The comparison results are delivered to an OR gate 25 as three output signals corresponding to the thermistors 13, 14 and 15.

For example, if the comparison result shows that the temperature detected by the center thermistor 13 (side thermistor 14, edge thermistor 15) is out of the range of reference temperature R5, the reference temperature R5 comparison circuit 23 delivers a corresponding output signal “1” to the OR gate 25. If the comparison result shows that the temperature detected by the center thermistor 13 (side thermistor 14, edge thermistor 15) is within the range of reference temperature R5, the reference temperature R5 comparison circuit 23 delivers a corresponding output signal “0” to the OR gate 25.

The OR gate 25 performs an OR operation on the basis of the three signals that are output from the reference temperature R5 comparison circuit 23. The OR gate 25 outputs the OR operation result to the OR gate 26. The OR gate 26 performs an OR operation on the basis of the output from the control section 21 and the output from the reference temperature R5 comparison circuit 23. If one of the output from the control section 21 and the output from the reference tempera-ture R5 comparison circuit 23 is “1”, the OR gate 26 delivers an output signal “1” to a reset circuit 27.

The reset circuit 27 is a circuit for turning off power that is supplied by turn-on of a main body power supply SW 28. If the OR gate 26 outputs “1”, the reset circuit 27 resets and turns off the power to the digital multi function peripheral.

Next, a surface temperature control operation for the heat roller 10 in the fixing device 1 with the above-described structure is described.

In the fixing device 1 with the above-described structure, the heat roller 10 rotates during a printing operation, and the heat roller 10 is at rest in the standby state. In addition, as shown in FIGS. 1 and 2, the center heater 11 and side heater 12 are not disposed at the diametrical center of the heat roller 10. Consequently, while the heat roller 10 is at rest (in the standby state), there is a difference in temperature distribution between the lower side and upper side of the heat roller 10 shown in FIGS. 1 and 2.

To be more specific, the center heater 11 is disposed on the lower side of the center of the heat roller 10. Thus, in the standby state, the center heater 11 heats the lower side of the heat roller 10 more than the upper side of the heat roller 10. On the other hand, the side heater 12 is disposed on the upper side of the center of the heat roller 10. In the standby state, the side heater 12 heats the upper side of the heat roller 10 more than the lower side of the heat roller 10.

Consequently, in the state in which the heat roller 10 is at rest, as shown in FIGS. 1 and 2, if a control is performed to equalize the temperatures (i.e., temperatures of the upper side of the heat roller 10) that are detected by the thermistors 13 and 14 disposed on the upper side of the heat roller 10, the temperature on the lower side of the heat roller 10 becomes higher at the center region corresponding to the center heater, and becomes lower at the side region corresponding to the side heater.

A description is now given of the surface temperature control for the heat roller 10 on the basis of the temperature detected by the thermistor 13 and the temperature detected by the thermistor 14. The surface temperature control for the heat roller 10, which is described below, aims at making uniform the entire center region corresponding to the center heater 11 and the entire side region corresponding to the side heater 12 so as to have a predetermined control-target temperature.

If the temperature that is detected by the thermistor 13 and the temperature that is detected by the thermistor 14 are controlled to have an equal temperature (control-target), the following phenomenon occurs. In the state in which the heat roller 10 stands at rest, the upper side of the surface of the heat roller 10 (where the thermistors 13 and 14 are disposed) has the control-target temperature at both the center region and side region. However, the lower side of the surface of the heat roller 10 (which is opposed to the position of the thermistor 13, 14) has a temperature higher than the control-target temperature at the center region and has a temperature lower than the control-target temperature at the side region.

This tendency becomes conspicuous if the wall thickness of the heat roller 10 decreases. In such a case, the temperature distribution in the longitudinal direction of the heat roller 10 becomes non-uniform. In particular, if the non-uniformity in temperature distribution of the heat roller 10 is great in the standby state (in which the heat roller 10 is at rest), the time that is needed to make uniform the surface temperature of the heat roller 10 increases. It is thus desirable to minimize the non-uniformity in temperature distribution of the heat roller 10 even in the standby state.

Assume that a printing operation is started (i.e., rotation of the heat roller 10 is started) in the state in which the temperature on the upper side of the heat roller 10 is controlled to have a control-target value at both the center region and side region, as mentioned above. In this case, the temperature distribution on the surface of the heat roller 10 is non-uniform, in particular, immediately after the start of rotation (driving) of the heat roller 10. If the heat roller 10 is rotated, the surface temperature of the entire heat roller 10 is gradually made uniform and reaches a control-target value. It is thus necessary to execute a control to make uniform the surface temperature of the heat roller 10 as much as possible, immediately after the heat roller 10 begins to rotate (i.e., immediately after the start of printing). For example, it is necessary to execute a control to make uniform the surface temperature of the heat roller 10 as much as possible during a period immediately after the start of rotation of the heat roller 10 until the completion of one rotation of the heat roller 10.

In consideration of the above-described circumstances, in the fixing device of this embodiment, the on/off control for the center heater 11 or side heater 12, which is based on the temperature detected by the thermistor 13, 14, is corrected on the basis of the positions of arrangement of the center heater 11, side heater 12 and thermistors 13 and 14. In this embodiment, corrections are made to attain the predetermined control-target temperature at the time of rest (standby state) of the heat roller 10, during a predetermined period after the start of rotation of the heat roller 10 and during a predetermined period after the stop of rotation of the heat roller 10.

A description will now be given of the surface temperature control of the heat roller 10 in the standby state (at the time of stop of the heat roller 10), immediately after the start of printing (immediately after the start of rotation of the heat roller 10) and immediately after the end of printing (immediately after the stop of rotation of the heat roller 10).

To begin with, the surface temperature control for the heat roller 10 in the standby state is described.

At the time the heat roller 10 is at rest, that is, in the standby state, an actual control-target value for the fixing device is set at a temperature value that is obtained by adding a predetermined correction value to a reference control-target value. The reference control-target value is a surface temperature of the heat roller 10 at the time of the fixing process. In the fixing device, it is desirable, as mentioned above, that the surface temperature of the entire heat roller 10 be uniformly set at the reference control target value at all times in the fixing process (print process).

For example, in the case where the center heater 11, side heaters 12 and thermistors 13 and 14 are arranged, as shown in FIGS. 1 and 2, the actual control-target value for the temperature detected by the thermistor 13 is set by adding a correction value to the reference control-target value. Thereby, even when the heat roller 10 is at rest, the surface temperature of the entire heat roller 10 can be made uniform as much as possible at a value near the reference control-target value.

Next, the surface temperature control for the heat roller 10 immediately after the start of printing is described.

During a period after the start of rotation of the heat roller 10, that is, immediately after the start of printing, an actual control-target value for the fixing device is set at a temperature value that is obtained by adding a correction value, which corresponds to the time from the start of rotation of the heat roller 10, to a reference control-target value. After passage of a predetermined time, the temperature of the heat roller 10 becomes uniform. Thus, without making correction, the reference control-target value is used as the actual control-target value. Thereby, immediately after the start of rotation of the heat roller 10 (immediately after the start of printing), the surface temperature of the entire heat roller 10 can be made uniform as much as possible at a value near the reference control-target value.

The correction value may be varied stepwise, or continuously, in accordance with the elapsed time from the start of rotation of the heat roller 10. For example, in the case where the correction value is varied stepwise, a plurality of correction values corresponding to the elapsed time from the start of rotation of the heat roller 10 are prestored in the memory 21b. Thereby, the control is executed based on the control-target value that is corrected by the correction value corresponding to the elapsed time from the start of rotation of the heat roller 10.

On the other hand, in the case where the correction value is varied continuously, an algorithm (e.g., computation formulae for computing a correction value based on elapsed time) for computing a correction value corresponding to the elapsed time from the start of rotation of the heat roller 10 is prestored in the memory 21b. Thereby, the correction value correspond-ing to the elapsed time from the start of rotation of the heat roller 10 is computed by the algorithm, and the control is executed based on the control-target value that is corrected by the computed correction value.

The surface temperature control for the heat roller 10 immediately after the end of printing is described.

During a period after the stop of rotation of the heat roller 10, that is, immediately after the end of printing, an actual control-target value for the fixing device is set at a temperature value that is obtained by adding a correction value, which corresponds to the time from the stop of rotation of the heat roller 10, to a reference control-target value. After passage of a predetermined time, control is executed based on the control target value that is corrected, as mentioned above, on the basis of the predetermined correction value in the state in which the heat roller 10 is at rest. Thereby, immediately after the stop of rotation of the heat roller (immediately after the end of printing), the surface temperature of the entire heat roller 10 can be made uniform as much as possible at a value near the reference control-target value.

The correction value may be varied stepwise, or continuously, in accordance with the elapsed time from the stop of rotation of the heat roller 10. For example, in the case where the correction value is varied stepwise, a plurality of correction values corresponding to the elapsed time from the stop of rotation of the heat roller 10 are prestored in the memory 21b. Thereby, the control is executed based on the control-target value that is corrected by the correction value corresponding to the elapsed time from the stop of rotation of the heat roller 10.

If the correction value is varied continuously, an algorithm (e.g., computation formulae for computing a correction value based on elapsed time) for computing a correction value corresponding to the elapsed time from the end of rotation of the heat roller 10 is prestored in the memory 21b. Thereby, the correction value corresponding to the elapsed time from the stop of rotation of the heat roller 10 is computed by the algorithm, and the control is executed based on the control-target value that is corrected by the computed correction value.

The above-described surface temperature control for the heat roller 10 is described referring to a specific example.

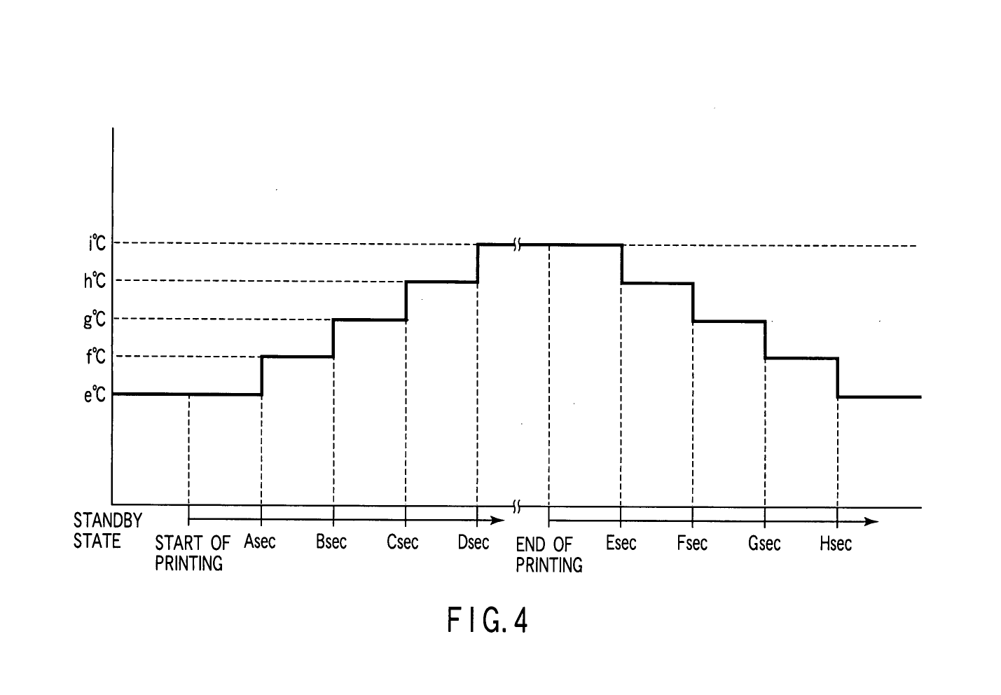

FIG. 4 illustrates an example of setting of a control-target value for the temperature detected by the thermistor 13, which is disposed on the upper side of the center region corresponding to the center heater 11 in the fixing device with the structure shown in FIGS. 1 and 2. FIG. 4 shows an example of setting of the actual control-target value for the detection temperature of the thermistor 13 immediately after the start of printing and immediately after the end of printing. In addition, FIG. 4 shows an example of setting of the control-target value in a case where correction corresponding to elapsed time is performed stepwise.

In the example shown in FIG. 4, to start with, the temperature that is detected by the thermistor 13 in the standby state is set at e(° C.). Specifically, in the standby state, the center heater 11 is on/off controlled so that the temperature detected by the thermistor 13 is e(° C.). If a reference control-target value in a state (steady state) after passage of a sufficient time from the start of rotation of the heat roller 10 is i(° C.), a correction value in the standby state is e−i(° C.).

After the start of rotation of the heat roller 10, that is, in a period between the start of printing and A(sec), control is executed so that the detection temperature of the thermistor 13 is set at e(° C.). In other words, in the period between the start of printing and A(sec), the center heater 11 is on/off controlled so that the temperature detected by the thermistor 13 may be set at e(° C.). Thus, a correction value in the period between the start of printing and A(sec) is e−i(° C.).

In a period between A(sec), from the start of printing, and B(sec), control is executed so that the detection temperature of the thermistor 13 is set at f(° C.). In other words, in the period between A(sec), from the start of printing, and B(sec), the center heater 11 is on/off controlled so that the temperature detected by the thermistor 13 may be set at f(° C.). Thus, a correction value in the period between A(sec), from the start of printing, and B(sec) is f−i(° C.).

In a period between B(sec), from the start of printing, and C(sec), control is executed so that the detection temperature of the thermistor 13 is set at g(° C.). In other words, in the period between B(sec), from the start of printing, and C(sec), the center heater 11 is on/off controlled so that the temperature detected by the thermistor 13 may be set at g(° C.). Thus, a correction value in the period between B(sec), from the start of printing, and C(sec) is g−i(° C.).

In a time period between C(sec), from the start of printing, and D(sec), control is executed so that the detection temperature of the thermistor 13 is set at h(° C.). In other words, in the period between C(sec), from the start of printing, and D(sec), the center heater 11 is on/off controlled so that the temperature detected by the thermistor 13 may be set at h(° C.). Thus, a correction value in the period between C(sec), from the start of printing, and D(sec) is h−i(° C.).

After D(sec) from the start of printing, control is executed so that the detection temperature of the thermistor 13 is set at i(° C.). In other words, after D(sec) from the start of printing, the center heater 11 is on/off controlled so that the temperature detected by the thermistor 13 may be set at i(° C.). Thus, after passage of D(sec) from the start of printing, a steady state is reached, in which there is no difference in temperature between the upper side and lower side of the heat roller 10.

As stated above, in the period between the start of printing and D(sec) in the steady state, the control-target value based on the detection temperature of the thermistor 13 is set stepwise so that the amount of correction may gradually decrease.

During stop of rotation of the heat roller 11, that is, in a period between the end of printing and E(sec), control is executed so that the detection temperature of the thermistor 13 is set at i(° C.). Specifically, in the period between the end of printing and E(sec), the center heater 11 is on/off controlled so that the temperature detected by the thermistor 13 is i(° C.). Thus, in the period between the end of printing and E(sec), a steady state is kept, in which there is no difference in temperature between the upper side and lower side of the heat roller 10.

In a period between E(sec), from the end of printing, and F(sec), control is executed so that the detection temperature of the thermistor 13 is set at h(° C.). In other words, in the period between E(sec), from the end of printing, and F(sec), the center heater 11 is on/off controlled so that the temperature detected by the thermistor 13 may be set at h(° C.). Thus, a correction value in the period between E(sec), from the end of printing, and F(sec) is h−i(° C.).

In a period between F(sec), from the end of printing, and G(sec), control is executed so that the detection temperature of the thermistor 13 is set at g(° C.). In other words, in the period between F(sec), from the end of printing, and G(sec), the center heater 11 is on/off controlled so that the temperature detected by the thermistor 13 may be set at g(° C.). Thus, a correction value in the period between F(sec), from the end of printing, and G(sec) is g−i(° C.).

In a period between G(sec), from the end of printing, and H(sec), control is executed so that the detection temperature of the thermistor 13 is set at f(° C.). In other words, in the period between G(sec), from the end of printing, and H(sec), the center heater 11 is on/off controlled so that the temperature detected by the thermistor 13 may be set at f(° C.). Thus, a correction value in the period between G(sec), from the end of printing, and H(sec) is f−i(° C.).

After H(sec) from the end of printing, control is executed so that the detection temperature of the thermistor 13 is set at e(° C.). In other words, after H(sec) from the end of printing, the center heater 11 is on/off controlled so that the temperature detected by the thermistor 13 may be set at e(° C.). Thus, a correction value after H(sec) from the end of printing is e−i(° C.).

As described above, in the period between the end of printing and H(sec) in the normal standby state, the control-target value based on the detection temperature of the thermistor 13 is set stepwise so that the amount of correction may gradually increases. In short, the amount of correction gradually increase after stop of the heat roller 10 and, after passage of predetermined time H(sec), correction is made using a predetermined correction value in the standby state.

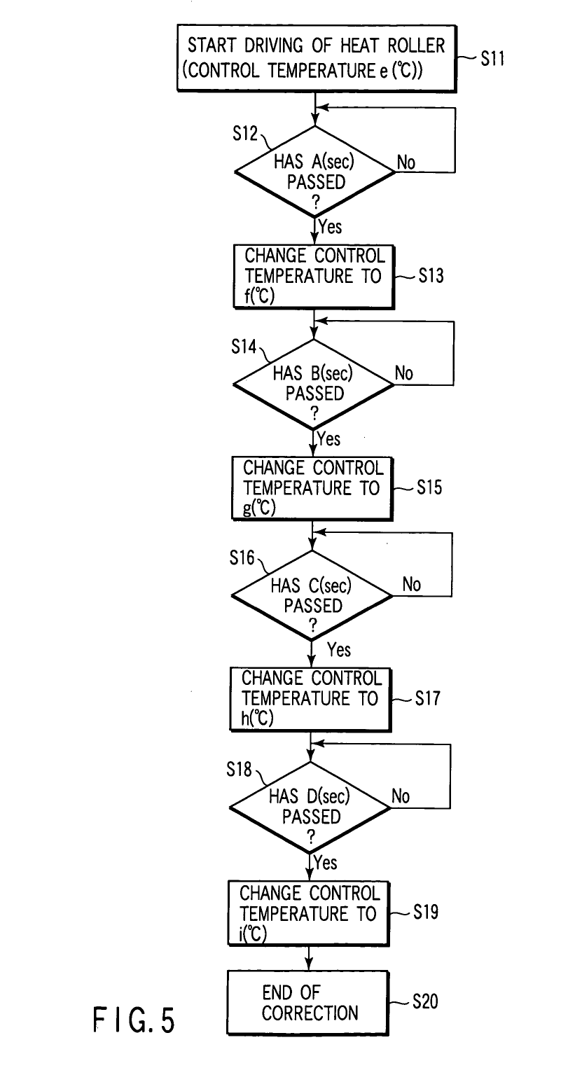

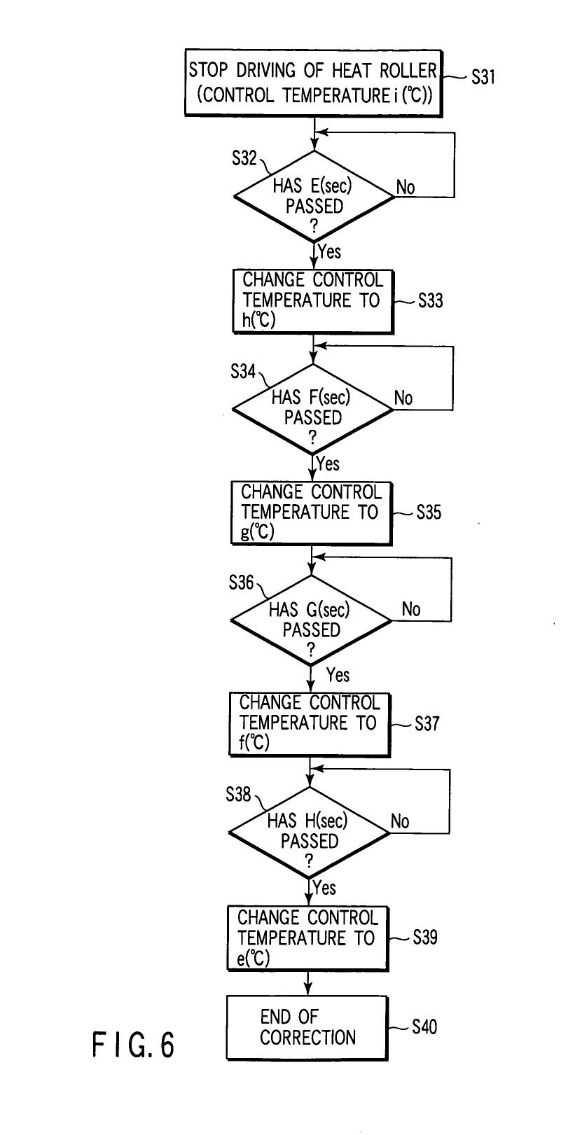

Referring now to the flowcharts of FIGS. 5 and 6, examples of the operation for realizing the above-described surface temperature control for the heat roller 10 are explained.

To begin with, a surface temperature control operation for the heat roller 10 immediately after the start of printing is described. FIG. 5 is a flowchart illustrating control immediately after the start of rotation of the heat roller 10 in the fixing device in which the stepwise control-target values corresponding to elapsed time are set, as shown in FIG. 4.

In the standby state, the control section 21 on/off controls the center heater 11 so that the temperature detected by the thermistor 13 may be set at a control-target value (e(° C.) in FIG. 4) in the standby state, which is stored in the memory 21b (step S11). This standby-state control-target value is an actual control-target value that is obtained by making correction to the reference control-target value (i(° C.) in FIG. 4), and this actual control-target value is stored in the memory 21b. As mentioned above, the reference control-target value is a control-target value in the state (steady state) after passage of a sufficient time from the start of rotation of the heat roller 10.

When the rotation of the heat roller 10 is started, that is, when printing is started (step S11), the control section 21 measures a time from the end of printing by means of the clock section (not shown). During a period between the start of printing and A(sec) (NO in step S12), the control section 21 on/off controls the center heater 11 so that the temperature detected by the thermistor 13 is e(° C.).

In other words, during the period between the start of printing and A(sec), the control section 21 sets at e(° C.) the control-target value for the temperature that is detected by the thermistor 13. This actual control-target value e(° C.) during the period between the start of printing and A(sec) is an actual control-target value that is obtained by making correction to the reference control-target value i(° C.). This actual control-target value is stored in the memory 21b.

After passage of A(sec) from the start of printing (YES in step S12), the control section 21 changes the control-target value for the detection temperature of the thermistor 13 to f(° C.) (step S13). If A(sec) passes from the start of printing, the control section 21 on/off controls the center heater 11 so that the temperature that is detected by the thermistor 13 may be set at f(° C.). The control-target value f(° C.) is kept between A(sec), from the start of printing, and B(sec) (NO in step S14). The actual control-target value f(° C.) in the period between A(sec), from the start of printing, and B(sec) is an actual control-target value that is obtained by making correction to the reference control-target value i(° C.) This actual control-target value is stored in the memory 21b.

After passage of B(sec) from the start of printing (YES in step S14), the control section 21 changes the control-target value for the detection temperature of the thermistor 13 to g(° C.) (step S15). If B(sec) passes from the start of printing, the control section 21 on/off controls the center heater 11 so that the temperature that is detected by the thermistor 13 may be set at g(° C.). The control-target value g(° C.) is kept between B(sec), from the start of printing, and C(sec) (NO in step S16). The actual control-target value g(° C.) in the period between B(sec), from the start of printing, and C(sec) is an actual control-target value that is obtained by making correction to the reference control-target value i(° C.). This actual control-target value is stored in the memory 21b.

After passage of C(sec) from the start of printing (YES in step S16), the control section 21 changes the control-target value for the detection temperature of the thermistor 13 to h(° C.) (step S17). If C(sec) passes from the start of printing, the control section 21 on/off controls the center heater 11 so that the temperature that is detected by the thermistor 13 may be set at h(° C.). The control-target value h(° C.) is kept between C(sec), from the start of printing, and D(sec) (NO in step S18). The actual control-target value h(° C.) in the time period between C(sec), from the start of printing, and D(sec) is an actual control-target value that is obtained by making correction to the reference control-target value i(° C.). This actual control-target value is stored in the memory 21b.

After passage of D(sec) from the start of printing (YES in step S18), the control section 21 changes the control-target value for the detection temperature of the thermistor 13 to i(° C.) (step S19). This control-target value i(° C.) is the reference control-target value. Thus, when D(sec) has passed from the start of printing, the control section 21 completes the correction to the reference control-target value (step S20). In addition, during the period between D(sec), from the start of printing, and the end of printing, the control section 21 on/off controls the center heater 11 by setting the control-target value for the detection temperature of the thermistor 13 at the reference control-target value i(° C.).

As has been described above, immediately after the start of rotation of the heat roller, that is, immediately after the start of printing, the heat roller is on/off controlled on the basis of the control-target value that is corrected in accordance with the elapsed time from the start of rotation of the heat roller. Thereby, immediately after the start of rotation of the heat roller, the non-uniformity in temperature distribution over the entire heat roller, which results from the arrangement of the heat roller, can be corrected. Even at a time immediately after the start of rotation of the heat roller, a high-quality fixing process can be performed.

In the fixing device of this embodiment, the control-target value for the surface temperature of the heat roller is set stepwise or continuously in accordance with the elapsed time from the start of rotation of the heat roller. Thereby, a high-quality fixing process can be realized immediately after the start of rotation of the heat roller.

Next, a surface temperature control operation for the heat roller 10 immediately after the end of printing is described. FIG. 6 is a flowchart illustrating control immediately after the end of rotation of the heat roller 10 in the fixing device in which the stepwise control-target values corresponding to elapsed time are set, as shown in FIG. 4.

During the printing operation (i.e., while the heat roller 10 is rotating in the steady state), the control section 21 on/off controls the center heater 11 so that the temperature detected by the thermistor 13 may be set at a reference control-target value (i(° C.) in FIG. 4), which is stored in the memory 21b (step S31). During the printing, the reference control-target value is used as the actual control-target value, because the temperature of the heat roller 10 is uniform in the rotational direction (i.e., uniform between the upper and lower sides) while the heat roller 10 is driven in the steady state.

When the rotation of the heat roller 10 is stopped, that is, when printing is completed (step S31), the control section 21 measures a time from the end of printing by means of the clock section (not shown). During a period between the end of printing and E(sec), the control section 21 on/off controls the center heater 11 so that the temperature detected by the thermistor 13 is set at i(° C.). In other words, during the period between the end of printing and E(sec) (NO in step S32), the control section 21 sets at i(° C.) the control-target value for the temperature that is detected by the thermistor 13. This actual control-target value i(° C.) during the period between the end of printing and E(sec) is equal to the reference control-target value that is stored in the memory 21b.

After passage of E(sec) from the end of printing (YES in step S32), the control section 21 changes the control-target value for the detection temperature of the thermistor 13 to h(° C.) (step S33). If E(sec) passes from the end of printing, the control section 21 on/off controls the center heater 11 so that the temperature that is detected by the thermistor 13 may be set at h(° C.). The control-target value h(° C.) is kept between E(sec), from the end of printing, and F(sec) (NO in step S34). The actual control-target value h(° C.) in the period between E(sec), from the end of printing, and F(sec) is an actual control-target value that is obtained by making correction to the reference control-target value i(° C.). This actual control-target value is stored in the memory 21b.

After passage of F(sec) from the end of printing (YES in step S34), the control section 21 changes the control-target value for the detection temperature of the thermistor 13 to g(° C.) (step S35). If F(sec) passes from the end of printing, the control section 21 on/off controls the center heater 11 so that the temperature that is detected by the thermistor 13 may be set at g(° C.). The control-target value g(° C.) is kept between F(sec), from the end of printing, and G(sec) (NO in step S36). The actual control-target value g(° C.) in the period between F(sec), from the end of printing, and G(sec) is an actual control-target value that is obtained by making correction to the reference control-target value i(° C.). This actual control-target value is stored in the memory 21b.

After passage of G(sec) from the end of printing (YES in step S36), the control section 21 changes the control-target value for the detection temperature of the thermistor 13 to f(° C.) (step S37). If G(sec) passes from the start of printing, the control section 21 on/off controls the center heater 11 so that the temperature that is detected by the thermistor 13 may be set at f(° C.). The control-target value f(° C.) is kept between G(sec), from the end of printing, and H(sec) (NO in step S38). The actual control-target value f(° C.) in the period between G(sec), from the end of printing, and H(sec) is an actual control-target value that is obtained by making correction to the reference control-target value i(° C.). This actual control-target value is stored in the memory 21b.

After passage of H(sec) from the end of printing (YES in step S38), the control section 21 changes the control-target value for the detection temperature of the thermistor 13 to e(° C.) (step S39). This control-target value e(° C.) is the control-target value after passage of H(sec) from the end of printing and is equal to the control-target value e(° C.) in the standby state. In short, after passage of H(sec) from the end of printing, the control section 21 finishes the stepwise correction of the control-target value in accordance with the elapsed time from the end of printing (step S40) and executes control based on the control-target value e(° C.) in the standby state.

If printing is started during the above-described control (i.e., during the period between the stop of the heat roller 10 and H(sec)), the control section 21 immediately starts printing. In this case, for example, the control section 21 may execute control for the start of printing from that step in FIG. 5, in which the control-target value, which is equal to the control-control value (temperature value) at the time of the start of printing, is set.

The above-described control for the time immediately after the start of printing and the control for the time immediately after the end of printing may be executed in combination. Thereby, even where printing is restarted immediately after the end of printing, the surface temperature of the heat roller 10 can be efficiently controlled to reach the reference control-target value as uniformly as possible.

As has been described above, immediately after the end of rotation of the heat roller, that is, immediately after the end of printing, the heat roller is on/off controlled on the basis of the control-target value that is corrected in accordance with the elapsed time from the stop of rotation of the heat roller. Thereby, immediately after the end of rotation of the heat roller, the non-uniformity in temperature distribution over the entire heat roller, which results from the arrangement of the heat roller, can be corrected. Consequently, even if printing is restarted immediately after the end of rotation of the heat roller (i.e., during the time between the stop of the heat roller and H(sec)), a high-quality fixing process can be performed.

In the fixing device of this embodiment, the control-target value for the surface temperature of the heat roller is set stepwise or continuously in accordance with the elapsed time from the stop of rotation of the heat roller. Thereby, a high-quality fixing process can be realized even if printing is started immediately after the stop of rotation of the heat roller.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A fixing device comprising:
a substantially cylindrical heat roller that is used for fixing toner on paper;
a center heater disposed within the heat roller, the center heater being located at a center region in a longitudinal direction of the heat roller and at a position displaced in a first direction from a diametrical center position of the heat roller;
a side heater disposed within the heat roller, the side heater being located at a side region in the longitudinal direction of the heat roller and at a position displaced in a second direction from the diametrical center position of the heat roller;
a first temperature detection element that detects a surface temperature of the heat roller at a position where a position in the longitudinal direction of the heat roller corresponds to the center heater; and
a second temperature detection element that is positioned in phase with the first temperature detection element in a circumferential direction of the heat roller, and detects a surface temperature of the heat roller at a position where a position in the longitudinal direction of the heat roller corresponds to the side heater.

2. The fixing device according to claim 1, further comprising a power supply turn-off element that turns off power to the center heater and the side heater when the surface temperature of the heat roller reaches a predetermined turn-off temperature,
wherein the first temperature detection element and the second temperature detection element are positioned in a phase different from a phase of the power supply turn-off element.

3. A fixing device comprising:
a substantially cylindrical heat roller that is used for fixing toner on paper;
a center heater disposed within the heat roller, the center heater being located at a center region in a longitudinal direction of the heat roller and at a position displaced in a first direction from a diametrical center position of the heat roller;
a side heater disposed within the heat roller, the side heater being located at a side region in the longitudinal direction of the heat roller and at a position displaced in a second direction from the diametrical center position of the heat roller;
a drive mechanism that rotates the heat roller in a circumferential direction thereof;
a first temperature detection element that detects a surface temperature of the heat roller at a position where a position in the longitudinal direction of the heat roller corresponds to the center heater;
a second temperature detection element that is positioned in phase with the first temperature detection element in the circumferential direction of the heat roller, and detects a surface temperature of the heat roller at a position where a position in the longitudinal direction of the heat roller corresponds to the side heater; and
a control section that controls, when driving of the heat roller is started by the drive mechanism, turning the center heater on or off using, as a control-target value of the surface temperature of the heat roller, a value that is obtained by correcting a reference control-target value for the surface temperature of the heat roller on the basis of a positional relationship between the center heater and the first temperature detection element, and also controls turning the side heater on or off using, as a control-target value of the surface temperature of the heat roller, a value that is obtained by correcting the reference control-target value for the surface temperature of the heat roller on the basis of a positional relationship between the side heater and the second temperature detection element.

4. The fixing device according to claim 3, wherein after passage of a predetermined time period from the start of driving of the heat roller by the drive mechanism, the control section controls turning the center heater or the side heater on or off using the reference control-target value as a control-target value of the surface temperature of the heat roller, without making said correction.

5. The fixing device according to claim 3, wherein the control section controls turning the center heater or the side heater on or off using, as a control-target value of the surface temperature of the heat roller, a value that is obtained by correcting the reference control-target value on the basis of a correction value that varies stepwise in accordance with an elapsed time from the start of driving of the heat roller by the drive mechanism.

6. The fixing device according to claim 3, wherein the control section controls turning the center heater or the side heater on or off using, as a control-target value of the surface temperature of the heat roller, a value that is obtained by correcting the reference control-target value on the basis of a correction value that varies continuously in accordance with an elapsed time from the start of driving of the heat roller by the drive mechanism.

7. A fixing device comprising:
a substantially cylindrical heat roller that is used for fixing toner on paper;
a center heater disposed within the heat roller, the center heater being located at a center region in a longitudinal direction of the heat roller and at a position displaced in a first direction from a diametrical center position of the heat roller;
a side heater disposed within the heat roller, the side heater being located at a side region in the longitudinal direction of the heat roller and at a position displaced in a second direction from the diametrical center position of the heat roller;
a drive mechanism that rotates the heat roller in a circumferential direction thereof;
a first temperature detection element that detects a surface temperature of the heat roller at a position where a position in the longitudinal direction of the heat roller corresponds to the center heater;
a second temperature detection element that is positioned in phase with the first temperature detection element in the circumferential direction of the heat roller, and detects a surface temperature of the heat roller at a position where a position in the longitudinal direction of the heat roller corresponds to the side heater; and
a control section that controls, when driving of the heat roller is stopped by the drive mechanism, turning the center heater on or off using, as a control-target value of the surface temperature of the heat roller, a value that is obtained by correcting a reference control-target value for the surface temperature of the heat roller on the basis of a positional relationship between the center heater and the first temperature detection element, and also controls turning the side heater on or off using, as a control-target value of the surface temperature of the heat roller, a value that is obtained by correcting the reference control-target value for the surface temperature of the heat roller on the basis of a positional relationship between the side heater and the second temperature detection element.

8. The fixing device according to claim 7, wherein after passage of a predetermined time period from the stop of driving of the heat roller by the drive mechanism, the control section controls turning the center heater or the side heater on or off using the reference control-target value as a control-target value of the surface temperature of the heat roller, without making said correction.

9. The fixing device according to claim 7, wherein the control section controls turning the center heater or the side heater on or off using, as a control-target value of the surface temperature of the heat roller, a value that is obtained by correcting the reference control-target value on the basis of a correction value that varies stepwise in accordance with an elapsed time from the stop of driving of the heat roller by the drive mechanism.

10. The fixing device according to claim 7, wherein the control section controls turning the center heater or the side heater on or off using, as a control-target value of the surface temperature of the heat roller, a value that is obtained by correcting the reference control-target value on the basis of a correction value that varies continuously in accordance with an elapsed time from the stop of driving of the heat roller by the drive mechanism.

11. A fixing method for use in a fixing device including a substantially cylindrical heat roller that is used for fixing toner on paper; a center heater disposed within the heat roller, the center heater being located at a center region in a longitudinal direction of the heat roller and at a position displaced in a first direction from a diametrical center position of the heat roller; a side heater disposed within the heat roller, the side heater being located at a side region in the longitudinal direction of the heat roller and at a position displaced in a second direction from the diametrical center position of the heat roller; and a drive mechanism that rotates the heat roller in a circumferential direction thereof, the method comprising:
detecting a surface temperature of the heat roller at a first temperature detection position where a position in the longitudinal direction of the heat roller corresponds to the center heater;
detecting a surface temperature of the heat roller at a second temperature detection position where a position in the longitudinal direction of the heat roller corresponds to the side heater, the second temperature detection position being in phase with the first temperature detection position in the circumferential direction of the heat roller; and
controlling, when driving of the heat roller is started by the drive mechanism, turning the center heater on or off using, as a control-target value of the surface temperature of the heat roller, a value that is obtained by correcting a reference control-target value for the surface temperature of the heat roller on the basis of a positional relationship between the center heater and the first temperature detection position, and also controlling turning the side heater on or off using, as a control-target value of the surface temperature of the heat roller, a value that is obtained by correcting the reference control-target value for the surface temperature of the heat roller on the basis of a positional relationship between the side heater and the second temperature detection position.

12. A fixing method for use in a fixing device including a substantially cylindrical heat roller that is used for fixing toner on paper; a center heater disposed within the heat roller, the center heater being located at a center region in a longitudinal direction of the heat roller and at a position displaced in a first direction from a diametrical center position of the heat roller; a side heater disposed within the heat roller, the side heater being located at a side region in the longitudinal direction of the heat roller and at a position displaced in a second direction from the diametrical center position of the heat roller; and a drive mechanism that rotates the heat roller in a circumferential direction thereof, the method comprising:
detecting a surface temperature of the heat roller at a first temperature detection position where a position in the longitudinal direction of the heat roller corresponds to the center heater;
detecting a surface temperature of the heat roller at a second temperature detection position where a position in the longitudinal direction of the heat roller corresponds to the side heater, the second temperature detection position being in phase with the first temperature detection position in the circumferential direction of the heat roller; and
controlling, when driving of the heat roller is stopped by the drive mechanism, turning the center heater on or off using, as a control-target value of the surface temperature of the heat roller, a value that is obtained by correcting a reference control-target value for the surface temperature of the heat roller on the basis of a positional relationship between the center heater and the first temperature detection position, and also controlling turning the side heater on or off using, as a control-target value of the surface temperature of the heat roller, a value that is obtained by correcting the reference control-target value for the surface temperature of the heat roller on the basis of a positional relationship between the side heater and the second temperature detection position.

13. An image forming apparatus that forms an image on paper, comprising:
a toner image forming section that forms a toner image on paper;
a substantially cylindrical heat roller that is used for fixing on the paper the toner image which is formed on the paper by the toner image forming section;
a center heater disposed within the heat roller, the center heater being located at a center region in a longitudinal direction of the heat roller and at a position displaced in a first direction from a diametrical center position of the heat roller;
a side heater disposed within the heat roller, the side heater being located at a side region in the longitudinal direction of the heat roller and at a position displaced in a second direction from the diametrical center position of the heat roller;
a first temperature detection element that detects a surface temperature of the heat roller at a position where a position in the longitudinal direction of the heat roller corresponds to the center heater; and
a second temperature detection element that is positioned in phase with the first temperature detection element in a circumferential direction of the heat roller, and detects a surface temperature of the heat roller at a position where a position in the longitudinal direction of the heat roller corresponds to the side heater.
